(19) United States
(12) Patent Application Publication
(10) Pub. No.: US 2026/0064181 A1
(43) Pub. Date: Mar. 5, 2026

(54) THRESHOLD POLICIES FOR SENSOR THRESHOLDS

(71) Applicant: SCHNEIDER ELECTRIC IT CORPORATION, Foxboro, MA (US)

(72) Inventor: Mikael Heinze, Kolding (DK)

(21) Appl. No.: 19/312,575

(22) Filed: Aug. 28, 2025

Related U.S. Application Data
(60) Provisional application No. 63/689,126, filed on Aug. 30, 2024.

(51) Int. Cl. G06F 1/3206

(52) U.S. Cl. CPC G06F 1/3206

(57) ABSTRACT

Examples of the disclosure include a method for applying sensor policies, the method comprising identifying a change in a sensor system, the change including a sensor being added to the sensor system or modified in the sensor system, determining, responsive to identifying the change in the sensor system, one or more sensor properties of the sensor, identifying one or more sensor policies applicable to the sensor based on the one or more sensor properties, and configuring the sensor with a sensor policy of the one or more sensor policies.

### CROSS-REFERENCE TO RELATED APPLICATIONS

This application claims priority under 35 U.S.C. § 119(e) to U.S. Provisional Application Ser. No. 63/689,126, titled “THRESHOLD POLICIES FOR SENSOR THRESHOLDS,” filed on Aug. 30, 2024, which is hereby incorporated by reference in its entirety.

### BACKGROUND

### 1. Field of the Disclosure

At least one example in accordance with the present disclosure relates generally to sensors.

### 2. Discussion of Related Art

Power devices, such as uninterruptible power supplies (UPSs), may be used to provide regulated, uninterrupted power for sensitive and/or critical loads, such as computer systems and other data-processing systems. Examples of UPSs include online UPSs, offline UPSs, line-interactive UPSs, as well as others. UPSs may provide output power to a load. The output power may be derived from a primary source of power, such as a utility-mains source, and/or derived from a back-up source of power, such as an energy-storage device. Sensors may be used to sense information related to the power devices.

### SUMMARY

Examples of the methods and systems discussed herein are not limited in application to the details of construction and the arrangement of components set forth in the following description or illustrated in the accompanying drawings. The methods and systems may be capable of implementation in other embodiments and of being practiced or of being carried out in various ways. Examples of specific implementations are provided herein for illustrative purposes and are not intended to be limiting. Acts, components, elements, and features discussed in connection with any one or more examples may be configured to operate and/or be implemented in a similar role in any other examples.

The phraseology and terminology used herein is for the purpose of description. References to examples, embodiments, components, elements, or acts of the systems and methods herein referred to in the singular may also embrace embodiments including a plurality. Similarly, references in plural to embodiments, components, elements, or acts may be implemented as a singularity. References in the singular or plural form may therefore not be intended to limit the presently disclosed systems or methods, their components, acts, or elements. The use herein of “including,” “comprising,” “having,” “containing,” “involving,” and variations so forth, may encompass the items listed thereafter and equivalents thereof as well as additional items.

References to “or” may be construed as inclusive so that any terms described using “or” may indicate any of a single, more than one, and all of the described terms. For example, the phrase “at least one of A or B” may refer A and/or B—that is, A only, B only, or A and B together. In addition, in the event of inconsistent usages of terms between this document and documents incorporated herein by reference, the term usage in the incorporated documents is supplementary to this document. For irreconcilable differences, the term usage in this document controls.

According to at least one aspect of the present disclosure include a method for applying sensor policies, the method comprising identifying a newly added sensor, determining, responsive to identifying the sensor, one or more sensor properties of the sensor, identifying one or more sensor policies applicable to the sensor based on the one or more sensor properties, and configuring the sensor with a sensor policy of the one or more sensor policies.

In at least one example, the method includes determining a respective priority ranking of each sensor policy of the one or more sensor policies. In at least one example, configuring the sensor includes configuring the sensor with a highest ranking sensor policy of the one or more sensor policies. In at least one example, configuring the sensor with the sensor policy includes applying a threshold condition to the sensor. In at least one example, the method includes receiving sensed information from the sensor, determining whether a sensed parameter derived from the sensed information satisfies the threshold condition, and executing one or more actions responsive to determining that the sensed parameter satisfies the threshold condition.

In at least one example, the one or more actions include causing an alarm indicative of the threshold condition being satisfied to be output. In at least one example, the threshold condition includes at least one of a threshold voltage value or a threshold current value being exceeded. In at least one example, the method includes determining that the one or more sensor properties satisfy one or more first policy parameters for a first sensor policy and one or more second policy parameters of a second sensor policy, and determining, based on the one or more sensor properties satisfying the one or more first policy parameters and the one or more second policy parameters, that the first sensor policy and the second sensor policy are applicable to the sensor.

In at least one example, the method includes determining, responsive to determining that the first sensor policy and the second sensor policy are applicable to the sensor, that the first sensor policy has a higher rank than the second sensor policy, the first sensor policy being associated with a first threshold condition and the second sensor policy being associated with a second threshold condition, and configuring the sensor with the first sensor policy and not the second sensor policy, wherein configuring the sensor with the first sensor policy includes determining that the first sensor policy is satisfied if the sensor provides at least one parameter value that satisfies the first threshold condition. In at least one example, the method includes outputting an indication of the first sensor policy and the second sensor policy, receiving a selection of one of the first sensor policy or the second sensor policy, and configuring the sensor with the selected one of the first sensor policy or the second sensor policy.

According to at least one example, at least one non-transitory computer-readable medium storing thereon sequences of computer-executable instructions for applying sensor policies is provided, the sequences of computer-executable instructions including instructions that instruct at least one processor to identify a newly added sensor, determine, responsive to identifying the sensor, one or more sensor properties of the sensor, identify one or more sensor policies applicable to the sensor based on the one or more sensor properties, and configure the sensor with a sensor policy of the one or more sensor policies.

In at least one example, the one or more sensor policies include a plurality of sensor policies. In at least one example, the instructions further instruct the at least one processor to determine a respective priority ranking of each sensor policy of the one or more sensor policies. In at least one example, the instructions further instruct the at least one processor to configure the sensor with a highest ranking sensor policy of the one or more sensor policies. In at least one example, configuring the sensor with the sensor policy includes applying a threshold condition to the sensor. In at least one example, the instructions further instruct the at least one processor to receive sensed information from the sensor, determine whether a sensed parameter derived from the sensed information satisfies the threshold condition, and execute one or more actions responsive to determining that the sensed parameter satisfies the threshold condition.

In at least one example, the one or more actions include causing an alarm indicative of the threshold condition being satisfied to be output. In at least one example, the threshold condition includes at least one of a threshold voltage value or a threshold current value being exceeded. In at least one example, the one or more sensor properties include at least one of a parameter that the sensor measures, a physical location of the sensor, a type of equipment that the sensor is associated with, a manufacturer of the equipment that the sensor is associated with, a model of the equipment that the sensor is associated with, or an identifier of the sensor.

In at least one example, the instructions further instruct the at least one processor to determine, based on the one or more sensor properties, that one or more unapplicable sensor policies are not applicable to the sensor. In at least one example, the instructions further instruct the at least one processor to determine that the one or more sensor properties satisfy one or more first policy parameters for a first sensor policy and one or more second policy parameters of a second sensor policy, and determine, based on the one or more sensor properties satisfying the one or more first policy parameters and the one or more second policy parameters, that the first sensor policy and the second sensor policy are applicable to the sensor.

In at least one example, the instructions further instruct the at least one processor to determine, responsive to determining that the first sensor policy and the second sensor policy are applicable to the sensor, that the first sensor policy has a higher rank than the second sensor policy, the first sensor policy being associated with a first threshold condition and the second sensor policy being associated with a second threshold condition, and configure the sensor with the first sensor policy and not the second sensor policy, wherein configuring the sensor with the first sensor policy includes determining that the first sensor policy is satisfied if the sensor provides at least one parameter value that satisfies the first threshold condition. In at least one example, the instructions further instruct the at least one processor to output an indication of the first sensor policy and the second sensor policy, receive a selection of one of the first sensor policy or the second sensor policy, and configure the sensor with the selected one of the first sensor policy or the second sensor policy.

According to at least one aspect of the disclosure, a system for applying sensor policies is provided, the system comprising a sensor, and at least one controller configured to identify the sensor, determine, responsive to identifying the sensor, one or more sensor properties of the sensor, identify one or more sensor policies applicable to the sensor based on the one or more sensor properties, and configure the sensor with a sensor policy of the one or more sensor policies.

In at least one example, the at least one controller is further configured to determine a respective priority ranking of each sensor policy of the one or more sensor policies. In at least one example, configuring the sensor includes configuring the sensor with a highest ranking sensor policy of the one or more sensor policies. In at least one example, configuring the sensor with the sensor policy includes applying a threshold condition to the sensor. In at least one example, the at least one controller is further configured to receive sensed information from the sensor, determine whether a sensed parameter derived from the sensed information satisfies the threshold condition, and execute one or more actions responsive to determining that the sensed parameter satisfies the threshold condition.

In at least one example, the one or more actions include causing an alarm indicative of the threshold condition being satisfied to be output. In at least one example, the threshold condition includes at least one of a threshold voltage value or a threshold current value being exceeded. In at least one example, the at least one controller is further configured to determine that the one or more sensor properties satisfy one or more first policy parameters for a first sensor policy and one or more second policy parameters of a second sensor policy, and determine, based on the one or more sensor properties satisfying the one or more first policy parameters and the one or more second policy parameters, that the first sensor policy and the second sensor policy are applicable to the sensor.

In at least one example, the at least one controller is further configured to determine, responsive to determining that the first sensor policy and the second sensor policy are applicable to the sensor, that the first sensor policy has a higher rank than the second sensor policy, the first sensor policy being associated with a first threshold condition and the second sensor policy being associated with a second threshold condition, and configure the sensor with the first sensor policy and not the second sensor policy, wherein configuring the sensor with the first sensor policy includes determining that the first sensor policy is satisfied if the sensor provides at least one parameter value that satisfies the first threshold condition. In at least one example, the at least one controller is further configured to output an indication of the first sensor policy and the second sensor policy, receive a selection of one of the first sensor policy or the second sensor policy, and configure the sensor with the selected one of the first sensor policy or the second sensor policy.

According to at least one aspect of the disclosure, a method for applying sensor policies is provided comprising identifying a change in a sensor system, the change including a sensor being added to the sensor system or modified in the sensor system, determining, responsive to identifying the change in the sensor system, one or more sensor properties of the sensor, identifying one or more sensor policies applicable to the sensor based on the one or more sensor properties, and configuring the sensor with a sensor policy of the one or more sensor policies.

In at least one example, the method includes determining a respective priority ranking of each sensor policy of the one or more sensor policies.

According to at least one aspect of the disclosure, at least one non-transitory computer-readable medium storing thereon sequences of computer-executable instructions for applying sensor policies is provided, the sequences of computer-executable instructions including instructions that instruct at least one processor to identify a change in a sensor system, the change including a sensor being added to the sensor system or modified in the sensor system, determine, responsive to identifying the change in the sensor system, one or more sensor properties of the sensor, identify one or more sensor policies applicable to the sensor based on the one or more sensor properties, and configure the sensor with a sensor policy of the one or more sensor policies.

In at least one example, the one or more sensor policies include a plurality of sensor policies. In at least one example, the instructions further instruct the at least one processor to determine a respective priority ranking of each sensor policy of the one or more sensor policies. In at least one example, configuring the sensor with the sensor policy includes applying a threshold condition to the sensor. In at least one example, the instructions further instruct the at least one processor to: receive sensed information from the sensor, determine whether a sensed parameter derived from the sensed information satisfies the threshold condition, and execute one or more actions responsive to determining that the sensed parameter satisfies the threshold condition. In at least one example, the threshold condition includes at least one of a threshold voltage value or a threshold current value being exceeded.

In at least one example, the one or more sensor properties include at least one of a parameter that the sensor measures, a physical location of the sensor, a type of equipment that the sensor is associated with, a manufacturer of the equipment that the sensor is associated with, a model of the equipment that the sensor is associated with, or an identifier of the sensor. In at least one example, the instructions further instruct the at least one processor to determine, based on the one or more sensor properties, that one or more unapplicable sensor policies are not applicable to the sensor. In at least one example, the instructions further instruct the at least one processor to: determine that the one or more sensor properties satisfy one or more first policy parameters for a first sensor policy and one or more second policy parameters of a second sensor policy, and determine, based on the one or more sensor properties satisfying the one or more first policy parameters and the one or more second policy parameters, that the first sensor policy and the second sensor policy are applicable to the sensor.

In at least one example, the instructions further instruct the at least one processor to: determine, responsive to determining that the first sensor policy and the second sensor policy are applicable to the sensor, that the first sensor policy has a higher rank than the second sensor policy, the first sensor policy being associated with a first threshold condition and the second sensor policy being associated with a second threshold condition, and configure the sensor with the first sensor policy and not the second sensor policy, wherein configuring the sensor with the first sensor policy includes determining that the first sensor policy is satisfied if the sensor provides at least one parameter value that satisfies the first threshold condition. In at least one example, the instructions further instruct the at least one processor to: output an indication of the first sensor policy and the second sensor policy, receive a selection of one of the first sensor policy or the second sensor policy, and configure the sensor with the selected one of the first sensor policy or the second sensor policy.

According to at least one example of the disclosure, a system for applying sensor policies is provided comprising a sensor, and at least one controller configured to identify the sensor, determine, responsive to identifying the sensor, one or more sensor properties of the sensor, identify one or more sensor policies applicable to the sensor based on the one or more sensor properties, and configure the sensor with a sensor policy of the one or more sensor policies.

In at least one example, the at least one controller is further configured to determine a respective priority ranking of each sensor policy of the one or more sensor policies. In at least one example, configuring the sensor with the sensor policy includes applying a threshold condition to the sensor. In at least one example, the at least one controller is further configured to: receive sensed information from the sensor, determine whether a sensed parameter derived from the sensed information satisfies the threshold condition, and execute one or more actions responsive to determining that the sensed parameter satisfies the threshold condition. In at least one example, the threshold condition includes at least one of a threshold voltage value or a threshold current value being exceeded.

In at least one example, the at least one controller is further configured to: determine that the one or more sensor properties satisfy one or more first policy parameters for a first sensor policy and one or more second policy parameters of a second sensor policy, and determine, based on the one or more sensor properties satisfying the one or more first policy parameters and the one or more second policy parameters, that the first sensor policy and the second sensor policy are applicable to the sensor. In at least one example, the at least one controller is further configured to: determine, responsive to determining that the first sensor policy and the second sensor policy are applicable to the sensor, that the first sensor policy has a higher rank than the second sensor policy, the first sensor policy being associated with a first threshold condition and the second sensor policy being associated with a second threshold condition, and configure the sensor with the first sensor policy and not the second sensor policy, wherein configuring the sensor with the first sensor policy includes determining that the first sensor policy is satisfied if the sensor provides at least one parameter value that satisfies the first threshold condition.

### BRIEF DESCRIPTION OF THE DRAWINGS

Various aspects of at least one embodiment are discussed below with reference to the accompanying figures, which may not be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or substantially similar component that is illustrated in various figures may be represented by a like numeral. For purposes of clarity, not every component may be labeled in every figure. In the figures:

FIG. 1 illustrates a block diagram of a system according to an example;

FIG. 2 illustrates a process for operating a system according to an example;

FIG. 3 illustrates a process for applying a sensor policy to a sensor according to an example;

FIG. 4 illustrates a process for identifying a sensor policy to configure a sensor with according to an example;

FIG. 5 illustrates a process of identifying a sensor policy to configure a sensor with according to another example; and

FIG. 6 illustrates a block diagram of a sensor-policy system according to an example.

### DETAILED DESCRIPTION

As discussed above, sensors may be used to sense various parameters of, or relating to, equipment in various settings. Sensors used to sense parameters of, or relating to, equipment may be considered to be used in connection with the equipment. For example, such equipment may include data servers, power-distribution units, rack power-distribution units, uninterruptible power supplies, cooling equipment, and so forth. Sensors used in connection with equipment may include, for example, voltage sensors, current sensors, temperature sensors, vibration sensors, humidity sensors, leak sensors and so forth. Sensors used in connection with equipment may include not only sensors internal to and/or physically contacting the equipment (for example, a current sensor used in a power supply) but also, in some examples, sensors that are external to and/or not physically contacting the equipment but that sense information relating to the equipment (for example, a leak sensor that is below cooling equipment to detect a leak from the cooling equipment).

Sensor systems include a group of sensors. Sensors may be added or removed from a sensor system, and existing sensors in a sensor system may be modified (for example, by moving a voltage sensor from one unit of equipment to another). Sensors may be added to a sensor system when a unit of equipment is first used, or after the unit of equipment is first used. Some sensor systems may require manual configuration for each individual sensor as the sensor system is modified. For example, configuring a sensor may include setting threshold conditions which may be satisfied depending on values sensed by the sensor. Such a threshold condition may include, for example, a voltage sensor detecting an overvoltage condition if the voltage sensor senses a voltage of 275 V or greater.

Manual configuration of a sensor can be time-consuming and prone to errors, especially in environments where new equipment is frequently added and/or modified. Manual configuration may involve specifying exact sensors and setting each sensor's corresponding configuration settings. When new sensors are added, administrators manually update the configuration, which can result in delays and potential misconfigurations. These solutions lack flexibility and scalability, as they may not account for the dynamic nature of modern sensor-system environments. The manual configuration of each sensor can therefore lead to inefficiencies and inconsistencies in monitoring and managing sensor data.

Examples discussed herein address these issues by introducing threshold policies that apply a threshold configuration to one or more sensors based on a set of sensor properties rather than specifying each sensor individually. For example, each sensor policy may have one or more sensor policy parameters indicating which sensors a respective policy is applicable to. When a sensor is added or modified, one or more sensor properties of the sensor may be identified, and a list of one or more applicable sensor policies may be identified based on those sensor properties. A sensor policy may then be selected from the one or more applicable sensor policies, and the sensor may be configured with that sensor policy. This approach may reduce the burden of configuring thresholds, especially in environments where new equipment is frequently added, and may ensure consistent and accurate monitoring of sensor data.

Current sensor-configuration systems, such as manual-configuration systems, may involve administrators manually determining which sensor policies are applicable to each sensor and choosing an applicable sensor policy to configure each sensor with. Such manual-configuration systems may operate inefficiently, because an administrator may be required to review a large number of sensor policies to identify applicable sensor policies. This is a technical problem. An exemplary embodiment of a sensor-configuration system discussed herein includes at least one non-transitory computer-readable medium storing thereon sequences of computer-executable instructions that instruct at least one processor to identify a newly added sensor, determine, responsive to identifying the sensor, one or more sensor properties of the sensor, identify one or more sensor policies applicable to the sensor based on the one or more sensor properties, and configure the sensor with a sensor policy of the one or more sensor policies.

At least this foregoing combination of features comprises a sensor-configuration system that serves as a technical solution to the foregoing technical problem. This technical solution is not routine and is unconventional. This technical solution is a practical application of the sensor-configuration-system design that solves the foregoing technical problem and constitutes an improvement in the technical field of sensor systems at least by reducing opportunities for human error and reducing the amount of time needed to configure a sensor system.

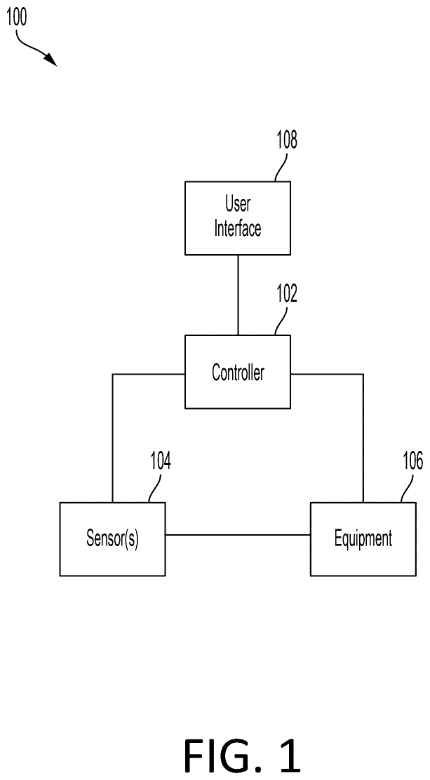

FIG. 1 shows a block diagram of a system 100 according to an example. The system 100 includes at least one controller 102 (“controller 102”), a sensor system 104 including one or more sensors, equipment 106, and at least one user interface 108 (“user interface 108”). The controller 102 is coupled to the sensor system 104, the equipment 106, and the user interface 108. The sensor system 104 is coupled to the controller 102 and the equipment 106. The equipment 106 is coupled to the controller 102 and the sensor system 104. The user interface 108 is coupled to the controller 102. In some examples, the user interface 108 may also be coupled to either or both of the sensor system 104 or the equipment 106.

The controller 102 communicates with the sensor system 104, the equipment 106, and the user interface 108. The controller 102 may be responsible for managing the interactions between the sensor system 104, the equipment 106, and the user interface 108. The controller 102 may execute various operations, such as identifying newly added or modified sensors, determining sensor properties, and applying sensor policies based on those properties.

The sensor system 104 includes one or more sensors of the same or different types, each configured to sense properties such as current, voltage, temperature, and/or other parameters. The sensor system 104 may be used to sense information relating to the equipment 106, which may include various types of devices, such as servers or HVAC units in data centers. For example, the sensor system 104 may include voltage and/or current sensors configured to sense voltage and/or current output by an uninterruptible power supply (UPS), a power-distribution unit (PDU), a rack power-distribution unit (RPDU), and so forth. The sensor system 104 may provide the sensed data to the controller 102 for further processing and evaluation.

The equipment 106 includes devices and/or systems such as power devices, data center equipment, or other components. For example, in an implementation in which the equipment 106 is utilized in a data center, the equipment 106 may include UPSs, PDUs, RPDUs, cooling equipment, servers, and so forth. In some examples, one or more sensors of the sensor system 104 may be integrated with the equipment 106 to monitor specific parameters and provide data to the controller 102. For example, the sensor system 104 may include a current sensor configured to sense a current output by a UPS of the equipment 106. In at least one example, one or more sensors of the sensor system 104 may be external to the sensor system 104 to monitor specific parameters and provide data to the controller 102. For example, the sensor system 104 may include a leak sensor configured to sense the presence or absence of a fluid leak below a cooling unit of the equipment 106. Sensors of the sensor system 104 may, in some examples, sense information relating to the equipment 106 without physically contacting or being integrated within any of the equipment 106.

The user interface 108 includes user input and/or output (I/O) components for interacting with a user. For example, the user interface 108 may include at least one display device to display information to a user, and/or at least one input device, such as a mouse, keyboard, touchscreen, and so forth, to receive user inputs from a user. In some examples, the user interface 108 allows users to input sensor properties, select sensor policies, view the status of the sensor system 104 and/or equipment 106, and so forth. In some examples, the controller 102 may identify various sensor policies applicable to sensors of the sensor system 104 and display the applicable sensor policies to the user for selection. In at least one example, the user interface 108 may include a user's smartphone or computer which may be communicatively coupled to the controller 102.

In various examples, the controller 102 may automatically select a sensor policy for configuring sensors of the sensor system 104, and may or may not display the selected sensor policy to a user for confirmation, editing, and/or review. In at least one example, the user may manually input the sensor properties via the user interface 108 or otherwise identify the sensor to the controller 102 through the user interface 108. In some examples, the controller 102 may automatically determine sensor properties (for example, by polling the sensor system 104 directly or by communicating with an external database storing information related to the sensor system 104) and may or may not display the determined sensor properties to a user for confirmation, editing, and/or review.

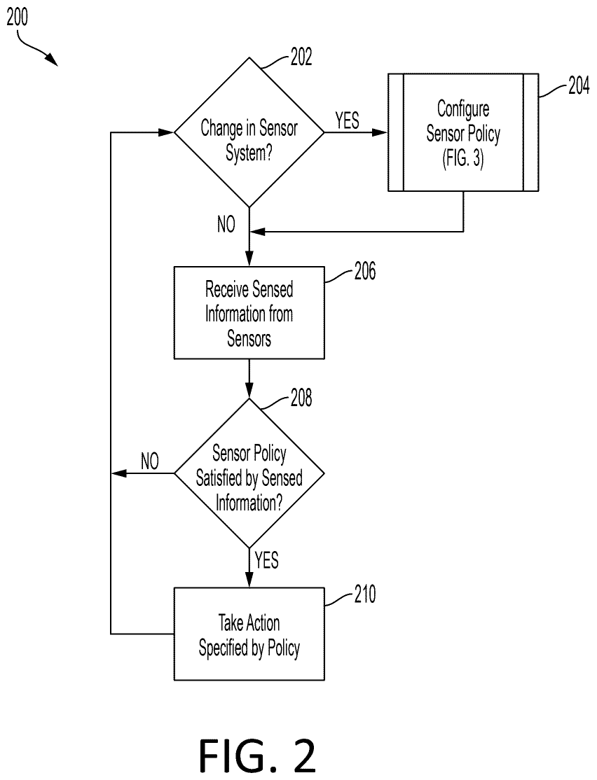

FIG. 2 illustrates a process 200 for operating a sensor system according to an example. The process 200 may be executed at least in part by the controller 102, and may include the controller 102 operating the sensor system 100.

At act 202, the controller 102 determines whether there are any changes in the sensor system 104. Changes may include newly added sensors being added to the sensor system 104, modifications to the sensor properties of existing sensors of the sensor system 104, updates to sensor policy parameters of the sensor policies, and so forth. In some examples, sensors may be integrated with units of the equipment 106, and the sensor system 104 may therefore change when units of the equipment 106 are added or removed. However, in other examples sensors may be added or removed from the sensor system 104 before or after units of the equipment 106 are added or removed. For example, a leak sensor may be installed beneath a unit of cooling equipment that has already been in use for several months; accordingly, act 202 may include the controller 102 determining that a change in the sensor system 104 is present even though no changes have been made to the equipment 106.

In some examples, additions and/or modifications may be automatically identified by the controller 102. For example, when a sensor is first powered on and coupled to the controller 102, the sensor may automatically send sensor properties describing the sensor (including, for example, a parameter that the sensor measures, a unit of the equipment 106 that the sensor is used with, and so forth) to the controller 102. The controller 102 may receive the sensor properties from the sensor and determine that there is a change in the sensor system 104.

In various examples, additions and/or modifications may be input by a user. For example, a user may manually input (for example, via the user interface 108) sensor properties for a newly added or modified sensor. The user may input the sensor properties via the user interface 108. The controller 102 may receive the sensor properties from the user interface 108 and determine that there is a change in the sensor system 104.

If the controller 102 determines that there is a change in the sensor system 104 (202 YES), then the process 200 continues to act 204.

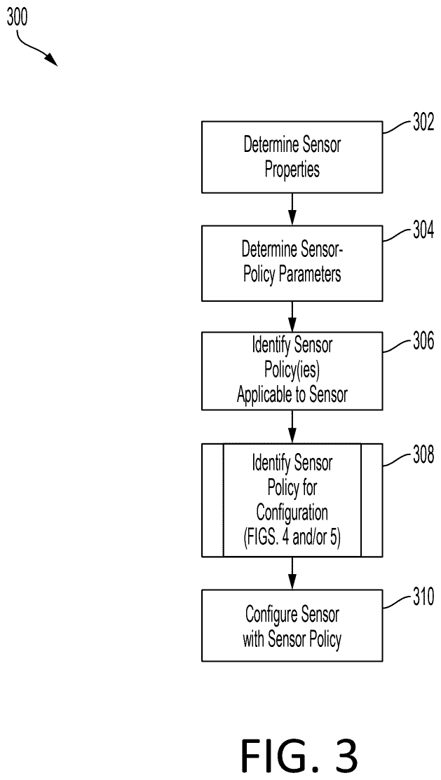

At act 204, the controller 102 configures the added or modified sensors with a sensor policy. Act 204 may include identifying an appropriate sensor policy based on the sensor properties and configuring the sensor with a selected sensor policy. Examples of act 204 are provided below with respect to FIG. 3. The process 200 then continues to act 206.

Returning to act 202, if the controller 102 does not identify any changes in the sensor system 104, then the process 200 bypasses act 204 and continues to act 206.

At act 206, the controller 102 receives sensed information from the sensor system 104. The sensor system 104 may monitor various parameters, such as current, voltage, temperature, and so forth, and may send sensed information indicative of the sensed parameters to the controller 102. The sensor system 104 may send the sensed information to the controller 102 continuously, periodically, aperiodically, responsive to the controller 102 polling the sensor system 104, a combination thereof, and so forth.

At act 208, the controller 102 determines whether a sensor policy has been satisfied based on the sensed information received from the sensor system 104. Act 208 may include determining whether the sensed parameters meet or exceed threshold conditions specified in the sensor policy. For example, consider a voltage sensor used in a UPS and configured to sense an output voltage of the UPS. The voltage sensor may be configured with a sensor policy that (potentially amongst other threshold conditions) specifies a threshold condition of 250 V. In this example, the sensor policy will be satisfied if the controller 102 receives sensed information from the sensor system 104 indicating that the voltage sensor senses a voltage above 250 V.

If the controller 102 determines that no sensor policy has been satisfied by the sensed information received at act 206 (208 NO), then the process 200 returns to act 202. Otherwise, if the controller 102 determines that at least one sensor policy has been satisfied by the sensed information received at act 206 (208 YES), then the process 200 continues to act 210.

At act 210, the controller 102 takes one or more actions as specified by a satisfied policy. Actions may include causing an alarm to be activated, sending notifications to a user, or triggering other automated responses to address the condition detected by the sensor. The controller 102 may control the user interface 108 in taking the one or more actions. For example, the user interface 108 may include an alarm or a device configured to output an alarm (For example, a computer terminal) that the controller 102 controls to activate the alarm. Automated responses may include controlling one or more components. For example, controlling one or more components may include opening or closing switching devices, powering components on or off, changing one or more devices'modes of operation, and so forth. Sensor policies may specify one or more different actions to ensure timely and appropriate responses to conditions monitored by the sensor system 104.

FIG. 3 illustrates a process 300 for applying a sensor policy to a sensor according to an example. The process 300 may be an example of act 204. As discussed above, configuring a sensor with a sensor policy includes determining the set of conditions which, if met by parameters sensed by the sensor, leads to the controller 102 taking one or more actions which are specified by the sensor policy.

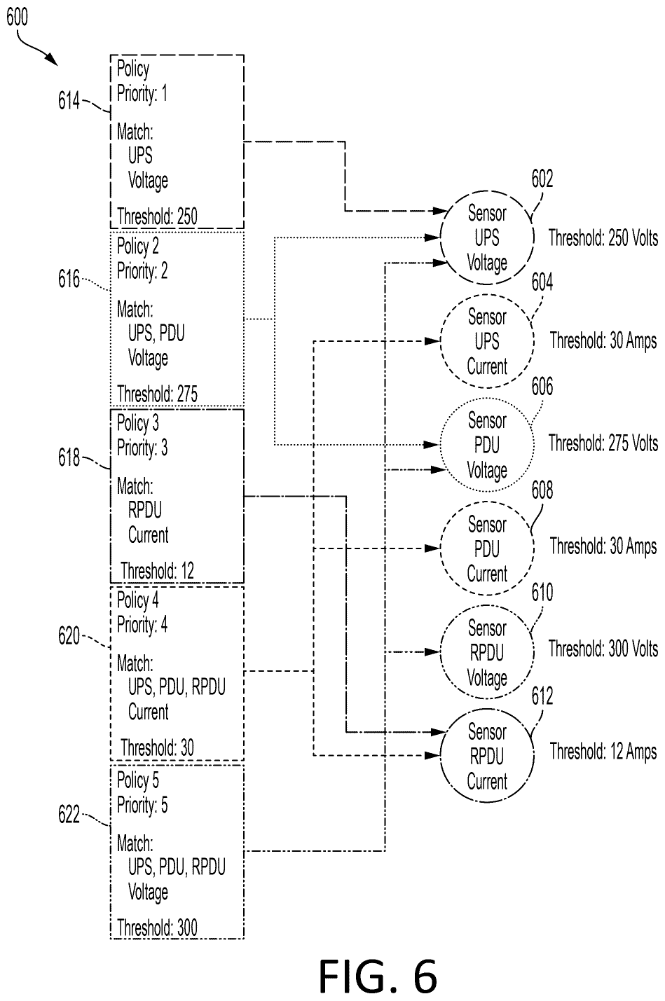

An example of the process 300 is described with respect to FIG. 6. FIG. 6 illustrates a block diagram of a sensor-policy system 600 according to an example. The sensor-policy system 600 illustrates an example of sensor policies and associated sensors in, for example, an environment such as a data center. The system 600 includes a first sensor 602, a second sensor 604, a third sensor 606, a fourth sensor 608, a fifth sensor 610, and a sixth sensor 612, as well as a first sensor policy 614, a second sensor policy 616, a third sensor policy 618, a fourth sensor policy 620, and a fifth sensor policy 622.

At act 302, the controller 102 determines one or more sensor properties for a sensor under consideration. In some examples, sensor properties may be manually input by a user. In various examples, the controller 102 may automatically identify the one or more sensor properties. For example, the controller 102 may receive the sensor properties directly from the sensor, and/or may receive the sensor properties from one or more external devices, such as a database storing information from a manufacturer of the sensor. In some examples, the controller 102 may query such a database with identifying information of the sensor to receive additional information about the sensor from the database.

Sensor properties may include properties describing the sensor or operation of the sensor. For example, sensor properties may include a parameter that the sensor measures (for example, voltage, current, temperature, humidity, vibrations, and so forth), a physical location of the sensor (for example, a room and rack in a data center that the sensor is used in), a type of equipment that the sensor is associated with (for example, a PDU, an RPDU, cooling equipment, a UPS, and so forth), a manufacturer of the sensor or the equipment that the sensor is associated with, a model of the sensor or the equipment that the sensor is associated with, a unique identifier of the sensor (for example, a serial number), a combination thereof, and so forth.

Using FIG. 6 as an example, the controller 102 may identify sensor properties for each of the sensors 602-612. For example, the controller 102 may determine that the first sensor 602 is configured to sense a UPS voltage, the second sensor 604 is configured to sense a UPS current, the third sensor 606 is configured to sense a PDU voltage, the fourth sensor 608 is configured to sense a PDU current, the fifth sensor 610 is configured to sense an RPDU voltage, and the sixth sensor 612 is configured to sense an RPDU current. In some examples, the sensors 602-612 may include additional or different sensor properties which the controller 102 may determine at act 302.

At act 304, the controller 102 determines one or more sensor-policy parameters for each potential sensor policy. The controller 102 may store, or have access to, many different sensor policies. Each sensor policy may be associated with a set of sensor-policy parameters. These sensor-policy parameters may indicate which sensor(s) the corresponding policy is applicable to. In other words, a sensor policy may be applicable to any sensors that have sensor parameters that match the sensor-policy parameters of the sensor policy. For example, these sensor-policy parameters may include parameters such as UPS-voltage sensors, UPS- or PDU-voltage sensors, RPDU-current sensors, UPS-, PDU- or RPDU-current sensors, UPS-, PDU-, or RPDU-voltage sensors, all temperature sensors, all temperature sensors manufactured by a particular manufacturer, temperature sensors of a particular model and manufactured by a particular manufacturer, all sensors in a given room of a data center, all voltage sensors in a given rack in a data center, all voltage sensors having a model released before 2020, and so forth. Sensor-policy parameters may include multiple different types of parameters and may or may not include logical operators such as AND, OR, XOR, and so forth, interrelating the various parameters.

Using FIG. 6 as an example, act 304 may include the controller 102 identifying sensor-policy parameters for each potential sensor policy, which may include the sensor policies 614-622. For ease of illustration, FIG. 6 only illustrates sensor policies which are applicable to one or more of the sensors 602-612, as discussed in greater detail with respect to act 306. In other examples, the controller 102 may have access to additional sensor policies which are not applicable to any of the sensors 602-612, such as sensor policies which are only applicable to temperature sensors. For clarity of illustration, the example of FIG. 6 does not depict sensor policies which are not applicable to at least one of the sensors 602-612.

Using the sensor policies 614, 616, and 622 as examples, act 304 may include the controller 102 determining sensor-policy parameters including that the first sensor policy 614 is applicable to UPS-voltage sensors, that the second sensor policy 616 is applicable to UPS- and PDU-voltage sensors, and that the fifth sensor policy 622 is applicable to UPS-, PDU-, and RPDU-voltage sensors.

At act 306, the controller 102 identifies one or more policies which are applicable to a sensor. The controller 102 identifies which policies are applicable to the sensor by determining which of the sensor policies have sensor-policy parameters determined at act 304 matching the sensor properties determined at act 302. For example, if a given sensor policy has the sensor-policy parameter “UPS-voltage sensors,” and the sensor has a sensor property of “UPS-voltage sensor,” then the controller 102 may determine that the sensor policy is applicable to the UPS-voltage sensor. Conversely, the sensor policy may not be applicable to a sensor having a sensor property of, for example, “UPS-current sensor. ” In various examples, multiple policies may be applicable to a given sensor. Continuing with the preceding example, if another sensor policy has the sensor-policy parameter “UPS- or PDU-voltage sensors,” then that sensor policy is also applicable to the UPS-voltage sensor.

Using FIG. 6 as an example, act 306 may include the controller 102 identifying which of the potential sensor policies are applicable to the sensors 602-612. As noted above, FIG. 6 only illustrates sensor policies which are applicable to one or more of the sensors 602-612 for ease of explanation. For example, for the first sensor 602, the controller 102 may determine that the first sensor policy 614, the second sensor policy 616, and the fifth sensor policy 622 are applicable to the first sensor 602. The first sensor policy 614 may be applicable to the first sensor 602 because the first sensor policy 614 is applicable to UPS-voltage sensors, and the first sensor 602 is a UPS-voltage sensor. The second sensor policy 616 may be applicable to the first sensor 602 because the second sensor policy 616 is applicable to PDU- and UPS-voltage sensors, and the first sensor 602 is a UPS-voltage sensor. The fifth sensor policy 622 may be applicable to the first sensor 602 because the fifth sensor policy 622 is applicable to PDU-, RPDU-, and UPS-voltage sensors, and the first sensor 602 is a UPS-voltage sensor.

In some examples, act 306 may also include identifying one or more sensor policies which are unapplicable to a sensor. For example, act 306 may include identifying the third sensor policy 618 and the fourth sensor policy 620 as unapplicable to the first sensor 602 in addition to or in lieu of identifying the first sensor policy 614, the second sensor policy 616, and the fifth sensor policy 622 as applicable to the first sensor 602.

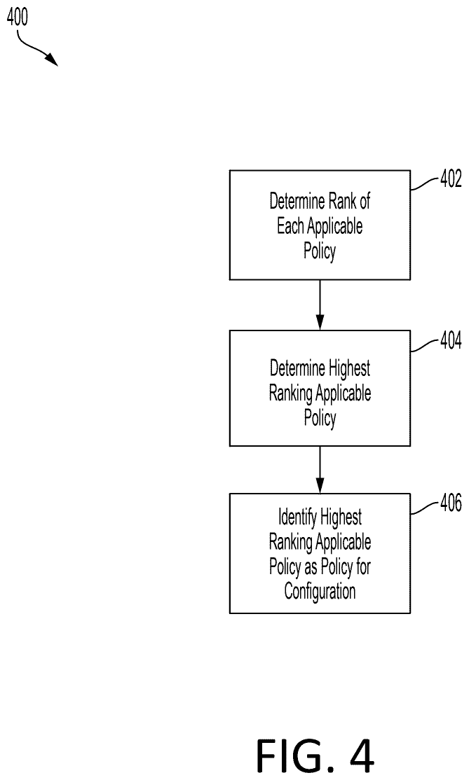

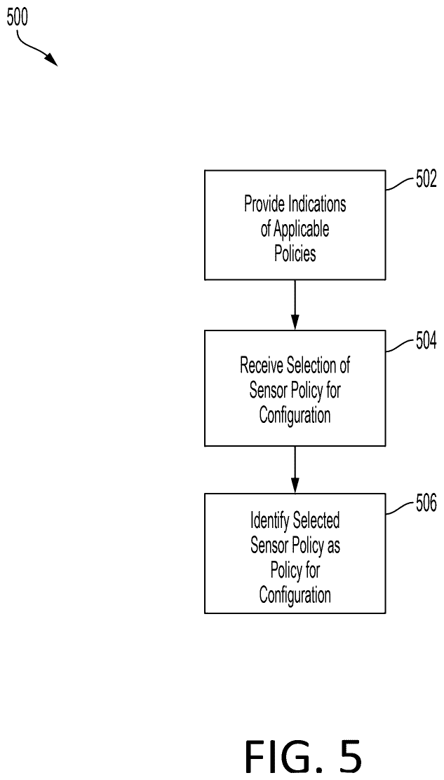

At act 308, the controller 102 identifies a sensor policy with which to configure the sensor. In some examples, act 306 may include identifying only a single sensor policy, and that sensor policy is selected to configure the sensor with at act 308. In other examples, act 306 may include identifying multiple sensor policies, and a single sensor policy is selected from those multiple sensor policies at act 308. Examples of act 308 are provided with respect to FIGS. 4 and 5.

At act 310, the controller 102 configures the sensor with the identified sensor policy for configuration. Configuring the sensor may include applying the one or more threshold conditions discussed above. For example, as discussed above with respect to act 208, implementing the one or more threshold conditions may include establishing conditions which, if satisfied by sensed information from the corresponding sensor (208 YES), may result in the controller 102 taking one or more actions specified by the sensor policy at act 210.

Using FIG. 6 as an example, act 310 may include the controller 102 configuring each of the sensors 602-612 with a respective sensor policy. As discussed in greater detail below with respect to FIG. 4, the first sensor policy 614 may be selected for configuring the first sensor 602. The first sensor policy 614 has a threshold condition of 250 V for UPS-voltage sensors.

Accordingly, the first sensor 602 is configured with the threshold condition of 250 V. The controller 102 may therefore determine that the threshold condition for the first sensor 602 is satisfied if the controller 102 receives sensed information from the first sensor 602 indicating that the first sensor 602 senses a voltage of 250 V or greater. The first sensor policy 614 may specify one or more actions to be taken if the controller 102 determines that the threshold condition is met, that is, that the first sensor 602 senses a voltage of 250 V or greater.

As discussed above, at act 308 the controller 102 may identify a sensor policy with which to configure a sensor. In some examples, the controller 102 may automatically identify a sensor policy with which to configure the sensor from the applicable sensor policy or policies identified at act 306. In various examples, the controller 102 may receive user input on which of the applicable sensor policy or policies to configure the sensor with. Examples are provided with respect to FIGS. 4 and 5.

FIG. 4 illustrates a process 400 for identifying a sensor policy to configure a sensor with according to an example. The process 400 may include identifying a highest ranking sensor policy to configure the sensor with. In some examples, the process 400 may be an example of act 308. However, the process 400 may also provide an example of identifying a sensor policy to configure a sensor with separate from the process 300. The process 400 may be executed after one or more applicable sensor policies have been identified. The process 400 may be executed at least in part by the controller 102.

At act 402, the controller 102 determines a rank for each applicable sensor policy of the one or more applicable sensor policies. In some examples, each sensor policy may have a pre-determined rank assigned to the respective sensor policy. In various examples, a sensor policy may have a rank that depends at least in part on how the sensor policy is applicable to the corresponding sensor. For example, a sensor policy may be applicable to both UPS-voltage sensors and PDU-voltage sensors. However, the sensor policy may have a different rank for UPS-voltage sensors than for PDU-voltage sensors.

In various examples, policy ranks may be determined at least in part based on a location of a sensor. For example, sensor policies for an individual rack may have priority over sensor policies for a room that the rack is in, which may in turn have priority over sensor policies for a given facility that the room is in, which may in turn have priority over sensor policies for a geographical region that the facility is in, and so forth. In some examples, in the event that two applicable sensor policies share a common rank, a sensor policy may be chosen based on considerations such as the location of the sensor and the location applicability of the sensor policies.

Using FIG. 6 as an example, each of the policies 614-622 has a respective priority ranking (or “rank”). For simplicity, the first sensor policy 614 has a rank of 1, the second sensor policy 616 has a rank of 2, the third sensor policy 618 has a rank of 3, the fourth sensor policy 620 has a rank of 4, and the fifth sensor policy 622 has a rank of 5, with “1” being the highest rank and “5”being the lowest rank.

Act 402 may therefore include the controller 102 analyzing each applicable sensor policy (for example, each applicable sensor policy of the policies 614-622) to identify the rank associated with the sensor policy for a given sensor (for example, of the sensors 602-610). Using the first sensor 602 as an example, for which the first sensor policy 614, the second sensor policy 616, and the fifth sensor policy 622 are applicable (for example, because each is applicable to UPS-voltage sensors), the controller 102 determines that the first sensor policy 614 has a rank of “1,” the second sensor policy 616 has a rank of “2,” and the fifth sensor policy 622 has a rank of “5.”

At act 404, the controller 102 determines which of the applicable sensor policies has the highest rank. Continuing with the example of the first sensor 602, the first sensor policy 614 has the highest rank (with a rank of “1”) of the three applicable sensor policies 614, 616, 622. Accordingly, the controller 102 may determine that the first sensor policy 614 is the highest ranking applicable sensor policy.

At act 406, the controller 102 identifies the highest ranking sensor policy as the sensor policy with which to configure the corresponding sensor. Continuing with the example of the first sensor 602, the controller 102 may identify the first sensor policy 614 as the sensor policy with which to configure the first sensor 602. As discussed above, configuring the first sensor 602 may include applying the threshold condition associated with the first sensor policy 614 (that is, the threshold voltage of 250 V) to the first sensor 602.

In some examples, act 404 may include determining which of several applicable sensor policies has the highest rank. As discussed above, for example, the first sensor 602 may have multiple applicable sensor policies, of which the first sensor policy 614 is the highest ranking. In other examples, act 404 may include a similar determination with only a single applicable sensor policy. For example, in the case of the second sensor 604, only the fourth sensor policy 620 may be applicable. Act 404 may thus include determining that the fourth sensor policy 620, which is the only applicable sensor policy, has the highest rank of any applicable sensor policy. Act 404 may therefore be executed even if only a single sensor policy is applicable to a given sensor.

In various examples, act 404 may include determining which of several low-ranking applicable sensor policies has the highest rank. For example, in the case of the sixth sensor 612, the third sensor policy 618 and the fourth sensor policy 620 are both applicable to the sixth sensor 612. The third sensor policy 618 has a rank of “3,” and the fourth sensor policy 620 has a rank of “4.” Although the first sensor policy 614 and the second sensor policy 616 both have higher ranks than the third sensor policy 618 and the fourth sensor policy 620, only the third sensor policy 618 and the fourth sensor policy 620 are applicable to the sixth sensor 612. Thus, although the third sensor policy 618 and the fourth sensor policy 620 are not the highest ranking sensor policies in the example of FIG. 6 overall, the third sensor policy 618 is the highest ranking applicable sensor policy and may thus be selected for configuring the sixth sensor 612.

In at least one example, the controller 102 may automatically configure each sensor with the highest ranking applicable sensor policy. In various examples, the controller 102 may or may not solicit user feedback or confirmation for an identified highest ranking applicable sensor policy. Using the first sensor 602 as an example, the controller 102 may or may not solicit user feedback or confirmation that the first sensor 602 should be configured using the first sensor policy 614. Soliciting user feedback or confirmation may include providing information to the user via the user interface 108 (for example, by displaying text and/or images to the user) and requesting that the user confirm that the first sensor 602 should be configured with the first sensor policy 614. In some examples, the controller 102 may also enable the user to modify aspects of the first sensor policy 614 prior to configuration, such as by allowing the user to modify the threshold condition (for example, changing the 250 V threshold to 275 V or 225 V), and/or modifying the one or more actions to be taken if the threshold condition is satisfied (for example, shutting down a unit of equipment rather than simply sending a notification to the user).

FIG. 5 illustrates a process 500 of identifying a sensor policy to configure a sensor with according to another example. The process 500 may include providing indications of one or more applicable sensor policies to a user for selection. In some examples, the process 500 may be an example of act 308. However, the process 500 may provide an example of identifying a sensor policy to configure a sensor with separate from the process 300. The process 500 may be executed after one or more applicable sensor policies have been identified. The process 500 may be executed at least in part by the controller 102.

At act 502, the controller 102 provides one or more indications of one or more applicable sensor policies to a user. For example, the controller 102 may display the one or more indications of the one or more applicable sensor policies via the user interface 108. The one or more indications of the one or more applicable sensor policies may include details of the applicable sensor policies. Such details may include, for example, the threshold condition(s) and the one or more actions to be taken in response to a sensor policy being satisfied.

At act 504, the controller 102 receives a selection of a sensor policy for configuring a sensor with. The controller 102 may receive the selection of the sensor policy via the user interface 108 from the user. The selected sensor policy may be one of the one or more applicable sensor policies provided to the user at act 502. In some examples, act 504 may include receiving modifications to a selected sensor policy. For example, the user may modify, via the user interface 108, the threshold condition(s) and/or the one or more actions to be taken in response to the sensor policy being satisfied.

At act 506, the controller 102 identifies the selected sensor policy as the sensor policy with which to configure the sensor. In examples in which a user modifies the selected sensor policy, act 506 may include the controller 102 identifying the modified sensor policy as the policy to configure the sensor with. As discussed above, configuring the sensor with the selected sensor policy may include taking one or more actions associated with the selected sensor policy if the threshold condition(s) of the selected sensor policy are satisfied.

Examples of the disclosure therefore include the controller 102 identifying one or more applicable sensor policies which may be applicable to a newly added or modified sensor. Applicable sensor policies may be identified by matching sensor properties to sensor-policy parameters. Of the applicable sensor policies, a sensor policy may be identified for configuration with or without user input. A selected sensor policy may then be used to configure the sensor.

As discussed above, configuring a sensor with a sensor policy may include determining one or more actions to be taken if threshold condition(s) are satisfied. The one or more actions may include, for example, activating one or more alarms such as haptic, visual, or auditory alarms, sending one or more notifications to a user, automatically activating, deactivating, or changing the mode of operation of one or more units of equipment, or any other actions to address a threshold condition being satisfied.

Threshold conditions discussed herein may include a parameter exceeding a threshold value, falling below a threshold value, being within a threshold range of values, being outside of a threshold range of values, or other conditions. Sensed parameters may include any of various parameters including, for example, current, voltage, temperature, humidity, and so forth. In some examples, sensed parameters may include parameters which are derivable from sensed information, such as power information derived from sensed current and/or voltage.

Various controllers, such as the controller 102, may execute various operations discussed above. The controller 102 may be or include one or more hardware components and may be or include processing circuitry. The controller 102 may also execute one or more instructions stored on one or more non-transitory computer-readable media, which the controller 102 may include and/or be coupled to, which may result in manipulated data. The one or more non-transitory computer-readable media may be or include hardware devices. The non-transitory computer-readable media may include memory and/or storage hardware. In some examples, the controller 102 may include one or more processors or other types of controllers. In one example, the controller 102 is or includes at least one processor. Example processors may include hardware components such as microprocessors. In another example, the controller 102 performs at least a portion of the operations discussed above using an application-specific integrated circuit tailored to perform particular operations in addition to, or in lieu of, a processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above. The computer-program product may be, or include, at least one hardware component configured to store and/or execute at least one computer program, and may be or include processing circuitry.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method for applying sensor policies, the method comprising:
identifying a change in a sensor system, the change including a sensor being added to the sensor system or modified in the sensor system;
determining, responsive to identifying the change in the sensor system, one or more sensor properties of the sensor;
identifying one or more sensor policies applicable to the sensor based on the one or more sensor properties; and
configuring the sensor with a sensor policy of the one or more sensor policies.

2. The method of claim 1, further comprising determining a respective priority ranking of each sensor policy of the one or more sensor policies.

3. At least one non-transitory computer-readable medium storing thereon sequences of computer-executable instructions for applying sensor policies, the sequences of computer-executable instructions including instructions that instruct at least one processor to:
identify a change in a sensor system, the change including a sensor being added to the sensor system or modified in the sensor system;
determine, responsive to identifying the change in the sensor system, one or more sensor properties of the sensor;
identify one or more sensor policies applicable to the sensor based on the one or more sensor properties; and
configure the sensor with a sensor policy of the one or more sensor policies.

4. The at least one non-transitory computer-readable medium of claim 3, wherein the one or more sensor policies include a plurality of sensor policies.

5. The at least one non-transitory computer-readable medium of claim 3, wherein the instructions further instruct the at least one processor to determine a respective priority ranking of each sensor policy of the one or more sensor policies.

6. The at least one non-transitory computer-readable medium of claim 3, wherein configuring the sensor with the sensor policy includes applying a threshold condition to the sensor.

7. The at least one non-transitory computer-readable medium of claim 6, wherein the instructions further instruct the at least one processor to:
receive sensed information from the sensor;
determine whether a sensed parameter derived from the sensed information satisfies the threshold condition; and
execute one or more actions responsive to determining that the sensed parameter satisfies the threshold condition.

8. The at least one non-transitory computer-readable medium of claim 6, wherein the threshold condition includes at least one of a threshold voltage value or a threshold current value being exceeded.

9. The at least one non-transitory computer-readable medium of claim 3, wherein the one or more sensor properties include at least one of a parameter that the sensor measures, a physical location of the sensor, a type of equipment that the sensor is associated with, a manufacturer of the equipment that the sensor is associated with, a model of the equipment that the sensor is associated with, or an identifier of the sensor.

10. The at least one non-transitory computer-readable medium of claim 3, wherein the instructions further instruct the at least one processor to determine, based on the one or more sensor properties, that one or more unapplicable sensor policies are not applicable to the sensor.

11. The at least one non-transitory computer-readable medium of claim 3, wherein the instructions further instruct the at least one processor to:
determine that the one or more sensor properties satisfy one or more first policy parameters for a first sensor policy and one or more second policy parameters of a second sensor policy; and
determine, based on the one or more sensor properties satisfying the one or more first policy parameters and the one or more second policy parameters, that the first sensor policy and the second sensor policy are applicable to the sensor.

12. The at least one non-transitory computer-readable medium of claim 11, wherein the instructions further instruct the at least one processor to:
determine, responsive to determining that the first sensor policy and the second sensor policy are applicable to the sensor, that the first sensor policy has a higher rank than the second sensor policy, the first sensor policy being associated with a first threshold condition and the second sensor policy being associated with a second threshold condition; and
configure the sensor with the first sensor policy and not the second sensor policy, wherein configuring the sensor with the first sensor policy includes determining that the first sensor policy is satisfied if the sensor provides at least one parameter value that satisfies the first threshold condition.

13. The at least one non-transitory computer-readable medium of claim 11, wherein the instructions further instruct the at least one processor to:
output an indication of the first sensor policy and the second sensor policy;
receive a selection of one of the first sensor policy or the second sensor policy; and
configure the sensor with the selected one of the first sensor policy or the second sensor policy.

14. A system for applying sensor policies, the system comprising:
a sensor; and
at least one controller configured to
identify the sensor,
determine, responsive to identifying the sensor, one or more sensor properties of the sensor,
identify one or more sensor policies applicable to the sensor based on the one or more sensor properties, and
configure the sensor with a sensor policy of the one or more sensor policies.

15. The system of claim 14, wherein the at least one controller is further configured to determine a respective priority ranking of each sensor policy of the one or more sensor policies.

16. The system of claim 14, wherein configuring the sensor with the sensor policy includes applying a threshold condition to the sensor.

17. The system of claim 16, wherein the at least one controller is further configured to:
receive sensed information from the sensor;
determine whether a sensed parameter derived from the sensed information satisfies the threshold condition; and
execute one or more actions responsive to determining that the sensed parameter satisfies the threshold condition.

18. The system of claim 16, wherein the threshold condition includes at least one of a threshold voltage value or a threshold current value being exceeded.

19. The system of claim 14, wherein the at least one controller is further configured to:
determine that the one or more sensor properties satisfy one or more first policy parameters for a first sensor policy and one or more second policy parameters of a second sensor policy; and
determine, based on the one or more sensor properties satisfying the one or more first policy parameters and the one or more second policy parameters, that the first sensor policy and the second sensor policy are applicable to the sensor.

20. The system of claim 19, wherein the at least one controller is further configured to:
determine, responsive to determining that the first sensor policy and the second sensor policy are applicable to the sensor, that the first sensor policy has a higher rank than the second sensor policy, the first sensor policy being associated with a first threshold condition and the second sensor policy being associated with a second threshold condition; and
configure the sensor with the first sensor policy and not the second sensor policy, wherein configuring the sensor with the first sensor policy includes determining that the first sensor policy is satisfied if the sensor provides at least one parameter value that satisfies the first threshold condition.
